(19) United States
(12) Patent Application Publication
(10) Pub. No.: US 2017/0148341 A1
(43) Pub. Date: May 25, 2017

(54) Methodology and system for teaching reading

(71) Applicants: David A. Boulton, Anchorage, KY (US); Kenny Pritchett, Anchorage, KY (US); Mark Shirkness, Anchorage, KY (US); Kirk Vandenberghe, Anchorage, KY (US); Joel Steres, Anchorage, KY (US); Braddock Gaskill, Anchorage, KY (US)

(72) Inventors: David A. Boulton, Anchorage, KY (US); Kenny Pritchett, Anchorage, KY (US); Mark Shirkness, Anchorage, KY (US); Kirk Vandenberghe, Anchorage, KY (US); Joel Steres, Anchorage, KY (US); Braddock Gaskill, Anchorage, KY (US)

(21) Appl. No.: 15/359,648

(22) Filed: Nov. 23, 2016

Related U.S. Application Data
(60) Provisional application No. 62/259,918, filed on Nov. 25, 2015.
(60) Provisional application No. 62/423,315, filed on Nov. 17, 2016.

(51) Int. Cl. G09B 17/00; G10L 13/08

(52) U.S. Cl. CPC G09B 17/006; G10L 13/08

(57) ABSTRACT

A system for visual encoding of words to assist learning to read including systematic variations in the appearance of letters which may look like morphic analogs of the sound variations they suggest (for example, barely visible grey for silent letters). By improving how letters cue sounds (like the alphabet originally did), visual encoding reduces the cognitive processing work that most impedes and endangers the progress of beginning and struggling readers (disambiguating letter-sound relationship confusion).

### CROSS REFERENCE TO RELATED APPLICATIONS

This application claims priority of copending provisional application Ser. No. 62/259,918, filed Nov. 25, 2015 and incorporated herein in its entirety by reference. This application also claims priority of copending provisional application Ser. No. 62/423,315, filed Nov. 17, 2016 and incorporated herein in its entirety by reference.

### BACKGROUND OF THE INVENTION

Field of the Invention

The present invention concerns teaching methodology and systems. More specifically, the present invention concerns methodology and systems for assessing and teaching reading

Description of the Related Art

According to the U.S. Department of Education's Institute of Educational Science and its latest National Assessment of Educational Progress (NAEP) report, approximately 60% of the 50.4 million students attending public school in the U.S. are reading below the proficiency level required for success in their grade levels. According to the Program for the International Assessment of Adult Competencies (PIAAC) 50% of the 240 million US adults have level 2 (rudimentary) or less reading abilities. Obviously the 150 million children and adults in the U.S. that are poor readers are in serious academic and economic danger. Less obviously, the consequence of these children and adults feeling (day after day, week after week, semester after semester, year after year) ‘not good enough at learning’ negatively warps every dimension of their lives.

The inability to decode words fast enough to sustain fluency is the most common bottleneck to progress for native English children and adults who struggle with reading. In order to retain in working memory the previously read words necessary for comprehension, and in order to sustain the attentional entrainment necessary for following the flow of meaning while reading, the decoding processes of unfamiliar word recognition must occur, on average across the letters in a word, in less than half a second per letter sound. While numerous factors exacerbate the challenge, the most common impediment to learning to decode words fast enough is the confusing relationships between letters and sounds in English orthography.

In English orthography letters do not represent single speech sounds (phonemes); they are interdependent placeholders for a range of possible sounds. For example, as shown in FIG. 1, there are 450 possible pronunciations for the combined letter sound values in the word “read”. 432 discrete letter combinations: 4 possible ‘r’ sound values, 6 possible ‘e’ sound values, 6 possible ‘a’ sound values, and 3 possible sound values (4×6×6×3). There are another 18 possible pronunciations when ‘r’ and ‘e’ are considered a group (1×1×6×3).

In English, a letter's actual sound value, in any particular word it is appearing, is determined by the sound values of the letters that accompany it (and in the case of heteronyms, by other words in the sentence. For example, consider the ambiguity in the sound of the letter ‘i’ in ‘live’: ‘I watched the debate live’ or ‘I live in Kentucky’.

U.S. Pat. No. 3,426,451 to Hoffmann discloses a phonetic alphabet that is particularly adapted to teaching young children how to read. Hoffmann discloses a phonic alphabet in which each of the letters employed looks sufficiently like the corresponding letter in regular type as to be immediately recognizable to the reader and, specifically so that each letter in the phonic alphabet has an outline identical to that of the letter used in the normal spelling of whatever word is involved. The invention of Hoffmann, however, does not cover “every sound which a spoken language may employ,” and thus fails to adequately address the problems discussed herein. Hoffmann further provides no teaching of any methodology or system for achieving the encoding it discloses, instead taking as a given some unnamed resource for achieving the encoding.

U.S. Pat. No. 4,270,284 to Skellings discloses a system for teaching by visual adjacency. Colors are used for recognition, absorption, retention to reinforce prior read portions of the language text for comparison. It makes apparent the features of languages and pro vides ready availability of linguistic, literary, and/or stylistic features to the student viewing the display. Skellings discloses a display that includes in a single frame text language in which at least two portions of the text language are emphasized by similar or identical colors that are different from the color of the text language or the background. Similar disclosures to Skellings may be found in U.S. Pat. No. 6,126,447 to Engelbrite and U.S. Pat. No. 3,715,812 to Novak. These references fail, however, to disclose any method or system for comprehensively encoding phonetic information in a reading teaching alphabet or similar construct.

It is therefore desired, among other goals, to have a system comprising a set of systematic variations in the visual appearance of letters that cue human readers to which of a letter's possible letter-sound values it should be pronounced/heard as in any particular word that it is appearing, which may comprise an additional layer of orthography over previously known orthographic systems.

### SUMMARY OF THE INVENTION

Today's text-to-speech capability is made possible by “online pronunciation dictionaries and speech synthesis systems” that match human-language written words with the machine-language instructions that computing devices use to produce sounds. A preferred embodiment of the present invention system builds from such online systems, but instead of using them to instruct a machine's sound system to produce speech uses the pronunciation information to systematically vary the appearance of letters in ways that reduce the confusion involved in sounding out words, that is, to visually encode. (The system of letter-face variations that guide pronunciation, i.e., the visual encoding, may be referred to at times by its trademark, “Pcues”.)

Just as bold, italics, and underline provide readers with cues that emphasize meaning, visual encoding may be variations in the appearance of letters that emphasize sounds—they cue readers to which of a letter's possible sounds it actually sounds like in the word in which it is appearing. There may be a small number of visual encoding that together cover the variations in letter-sounds most confusing to beginning and struggling readers.

Visual encoding may be systematic variations in the appearance of letters that look like morphic analogs of the sound variations they suggest (for example, barely visible grey for silent letters). By improving how letters cue sounds (like the alphabet originally did), visual encoding reduces the cognitive processing work that most impedes and endangers the progress of beginning and struggling readers (disambiguating letter-sound relationship confusion).

The foregoing Summary of the Invention is not intended to limit the scope of the disclosure contained herein nor limit the scope of the appended claims. To the contrary, as will be appreciated by those persons skilled in the art, variations of the foregoing described embodiments may be implemented without departing from the claimed invention.

### BRIEF DESCRIPTION OF THE DRAWINGS

The objects and features of the invention may be understood with reference to the following detailed description of an illustrative embodiment of the present invention taken together in conjunction with the accompanying drawings in which: FIG. 1 is a depiction of an encoding in accordance with a preferred embodiment of the present invention.

FIG. 2 is a depiction of a eight of the sound value visual encoding patterns of the letter ‘A’ in accordance with a preferred embodiment of the present invention.

FIGS. 3A-3C are depictions of variable encoding types in accordance with a preferred embodiment of the present invention.

FIGS. 4A-4C are depictions of font rendering encoding types in accordance of with a preferred embodiment of the present invention.

FIGS. 5A-5B are depictions of other font rendering encoding types in accordance of with a preferred embodiment of the present invention.

FIGS. 6A-6B are depictions of segmentation encoding in accordance of with a preferred embodiment of the present invention.

FIG. 7A is a depiction of rendering options for alternate letter sounds comprising discretely different alternative letter sounds in accordance with a preferred embodiment of the present invention.

FIG. 7B is a depiction of rendering options for alternate letter sounds comprising spectrum (“a”, “ae”, “aw”, etc.) letter alternate sounds in accordance with a preferred embodiment of the present invention.

FIG. 8A is a depiction of rendering options comprising rotation for spectrum cues and elevation for discrete cues in accordance with a preferred embodiment of the present invention.

FIG. 8B is a depiction of other rendering options comprising rotation for spectrum cues and elevation for discrete cues in accordance with a preferred embodiment of the present invention.

FIG. 9 is a flow chart depicting the general logical flow of the PCUE automation system in accordance with a preferred embodiment of the present invention.

FIG. 10 is a flow chart depicting the logical flow of the proof output of the PCUE automation system in accordance with a preferred embodiment of the present invention.

FIG. 11 is a flow chart depicting the logical flow of a reader app and browser plug-in having are analogous “receivers” or “players” designed to display pre visually encoded texts or to process any other texts into visually encoded text via the PCUE automation system in accordance with a preferred embodiment of the present invention.

FIG. 12 is a depiction of a phonetic transcription based encoding in accordance with a preferred embodiment of the present invention.

FIG. 13 is a depiction of orthographical mappings in accordance with a preferred embodiment of the present invention.

FIG. 14 is a depiction of visual encoding mappings in accordance with a preferred embodiment of the present invention.

FIG. 15 is a depiction of visual encoding mappings in accordance with a preferred embodiment of the present invention.

FIG. 16 is a depiction of a GUI dialog box that enables human users to assign single letter, segmentation, and group style codes visually in accordance with a preferred embodiment of the present invention.

FIG. 17 is a depiction of a visual encoding visual style types used to classify and process any lexicon/dictionary (including for example “classroom aggregate”, “personal” and “generic” vocabulary lists) into lists of words according to visually encoded type/style variations in accordance with a preferred embodiment of the present invention.

FIG. 18 is a depiction of an assisted teaching tool used to search dictionaries such as personal, class-aggregate, grade-level and generic dictionaries to find and present to students words that exemplify the coded sound value of the letter with which the student is interacting, presenting to the student a known word in accordance with a preferred embodiment of the present invention.

FIG. 19 is a depiction of a display of one of the K-Grade Word-Pictures from the Vocabulary Assessment Dictionary in accordance with a preferred embodiment of the present invention.

FIG. 20 is a depiction of a Sight Word Vocabulary Assessment that allows students to match spoken words to printed words, thereby assessing which words are in a student's personal sight word vocabulary in accordance with a preferred embodiment of the present invention.

### DESCRIPTION OF THE PREFERRED EMBODIMENT

Embodiments of the present invention concern a systematic coding of the sound variations associated with letters and letter combinations used to (1) codify the letters-to-sounds patterns in the English (or other) lexicon and (2) vary the visual appearance of letters to indicate which of a letter's possible sounds it is actually making in each word it is appearing.

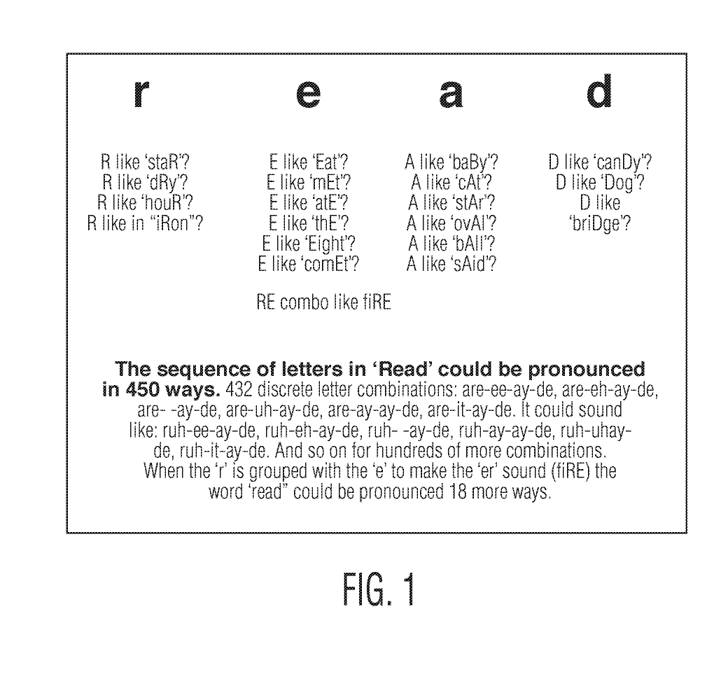

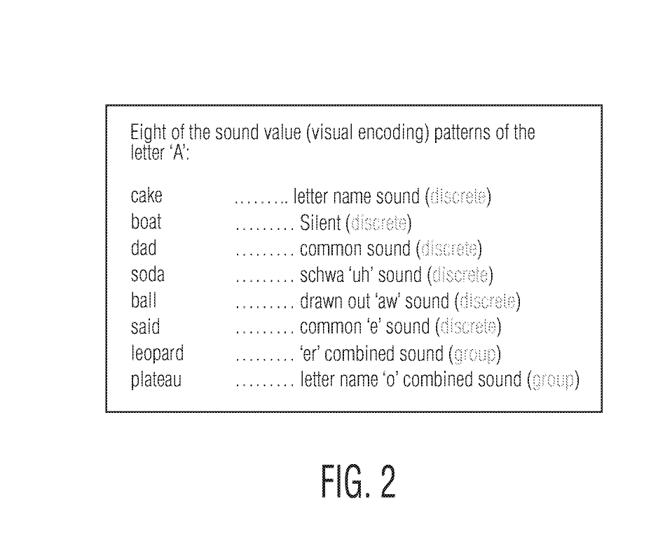

Embodiments of the present invention may be in the form a codification system that represents the possible letter-sound values (phonemes) of the letters in the alphabet in which are represented each letter's possible discrete sound values as well as each of the group-sound values (phonemes) it can participate in representing when combined or blended with a neighbor letter or letters. An illustration of sound value patterns is depicted in FIG. 2.

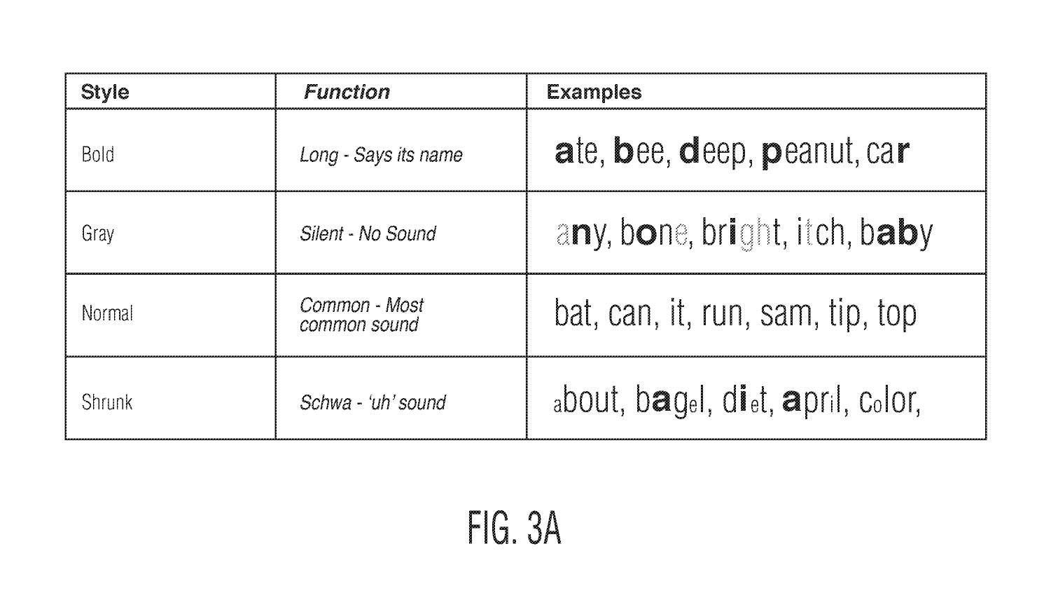

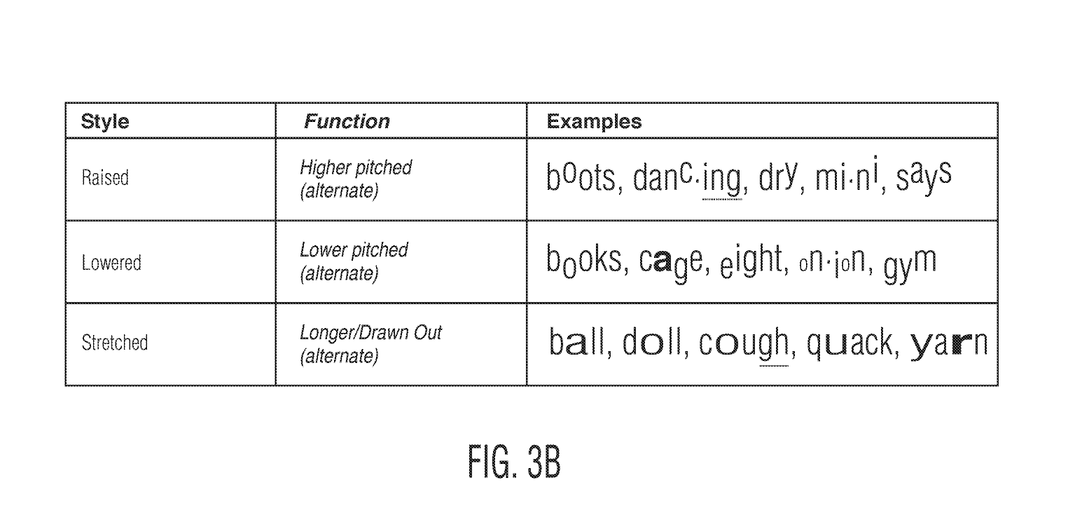

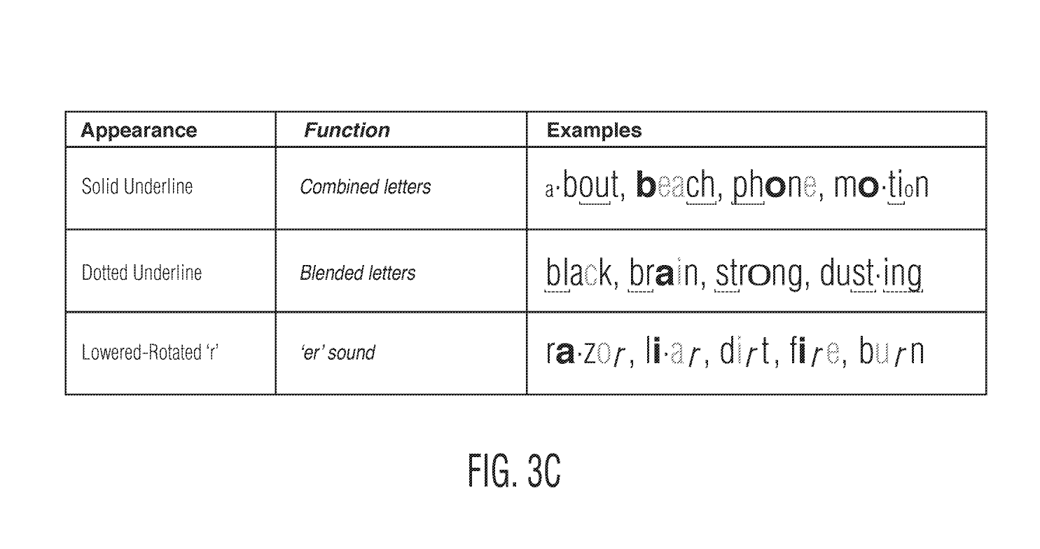

In certain embodiments of the present invention, core encoding specify letter-sound types that implicitly define a letter's actual sound value, also known as its sound function. For example most letters can sound like their letter names, also called “long” sounds, either alone (e.g., the “a” in “ate”) or in combination with other letters such as vowels (e.g., the “b” in “bee”), their most common sound (as in the “c” in “cat”), or they can be silent (as in the “a” in “boat”). Knowing that a letter is making its letter-name-sound, or most common sound, or is silent implicitly specifies its actual sound value. Core encoding types may always specify actual letter-sound values, thus eliminating letter-sound ambiguity. Each type may be rendered as a separate and distinct visual style. For example, FIG. 3A depicts one possible style system in accordance with the present invention.

In certain embodiments of the present invention, variable encoding types do not necessarily define actual letter-sound values (though they can as in the case of the raised ‘c’ always=‘s’). Variable encoding types may specify the possible non-Core letter-sound values for a given letter (for example the ‘a’ sound of e′ (eight) or the ‘z’ sound of ‘s’ (cities). Variable encoding types reduce the field of possible letter-sound values (reduce ambiguity) by eliminating all the fixed encoding type options and representing the remaining possible letter-sound values as variations in sound (higher in pitch, lower in pitch, drawn out). Each variable encoding type may be rendered in a separate and distinct encoding style. One example is shown in FIG. 3B.

Group-Variable encoding types may also specify a sub-set of possible letter-sound values but instead of representing a discrete letter's letter-sound value they represent the group-sound values possible when a given letter is combined or blended with a neighboring letter or letters. These encoding types may reduce the field of possible letter-sound values of a given letter (reduce ambiguity) by eliminating all of its discrete letter-sound value options and indicating that the remaining possible sound-values options are a sub-set of the letter's possible group-sound val ues (for example combinations with the letter ‘o’: ‘or’ (horn), ‘or’ (razor), ‘ow’ (cow), ‘ou’ (mouse), ‘oy’ (toy), ‘oi’ (boil), ‘our’ (hour), ‘our’ (four)). Each group-variable encoding type is rendered in a separate and distinct encoding style. FIG. 3C shows examples of such group variable encoding in accordance with embodiments of the present invention.

In certain embodiments, whenever possible, encodings are rendered/styled as visual morphic analogs of the sound variations they represent (e.g., letter name=bold, silent=gray, higher pitched sound=elevated, drawn out sound=stretched, combined letters underlined as a group).

The codification of the words may be used or chosen in student surveys (referred to as “Assessments PSA”) and recognized on sight or when heard during student vocabulary assessments (Assessments PVA and VA) into smartly tagged student vocabulary words (referred to as “Elements ASWs”).

Codified student vocabulary words (Elements ASWs) may be used to construct studentspecific (1) phonemic awareness and articulation exercises (Exercises A-Z) and assessments (Assessments A-Z) and (2) sight-word sentence exercises (Exercises SWS) and assessments (Assessments SWS).

Visual encoding may be used to filter student vocabulary words (Elements ASWs) into student exercise words and word lists that target (isolate and vivify) the student's learning of letterssounds patterns. Visual encoding logic may be used to:
1—Filter student's words (ASWs) by type of letter-sound confusion (Kinds of Confusion)
2—Create lists of student exercise words whose constituent letters exemplify a type of confusion and do not include more complex patterns of letter-sound relationships (Exercises WME).
3—Use above lists to exercise student's ability to identify and “mark” the letters that match selected/targeted visually encoded patterns (Exercises WME)
4—Use of above lists to assess student's ability to identify and “mark” the letters that match one of the visual encoding patterns (Assessments WM)
5—Use the words that students had difficulty recognizing visually encoded patterns in as subjects subject of word recognition exercises.

Embodiments of the present invention may separate a cue's logical function (what kind of letter-sound confusion it addresses) from a cue's rendering (how the visual variation in a cued letter or letters looks). In embodiments of the present invention, the logic of cues (visual encoding logic) and how cues are rendered (visual encoding) may be separate processes.

In order to assign visual encoding font-rendering variations (i.e., typeface variations), embodiments of the present invention may delineate the sound variations they are to cue. Here such embodiments may depart from the already literate expert labeling conventions used by linguists and orthographists (vowels, consonants, diphthongs, trigraphs, etc.,) and focus instead on the kinds of confusion beginning and struggling readers experience:
Does it sound like its letter-name? One of the difficult confusions for developing readers is a consequence of learning the ABCs (letter-name sounds) and the ABC song. Because most children learn the “ABCs” before they begin to learn to read, their brain's learn (neurons wire and fire) to associate a letter with its letter name sound. When later learning to read, their brains' response to seeing a letter is to “hear” its letter name. As it is often the case that letters don't sound like their letter names, this association confuses the process of learning to read. If not a letter-name, which of its other sounds? Letters have letter-name sounds and many letters have more than one non-letter name sound.
Is it a silent letter? Some letters are not pronounced, as in the case of the “a” in “sea” and the “k” and “w” in know.
Does it stand alone or combine with others? Combined letter sounds are in a class by themselves. The problem with combined letter sounds is recognizing that their individual letters are not to be decoded separately but combined to represent their distinctly assigned sounds.
Does its sound run together with its adjacent letters' sounds or is there a syllable/segment pause in sound before or after it?

Visual encoding may provide readers cues which let them know when a letter sounds like it's letter name and when it doesn't; whether a letter is silent, which of a letter's non-letter name sounds it's making, whether a letter is part of a larger unit with it's own sound, and where the segments of pronunciation are in the word they are reading.

Within existing font technology, there are a number of ways (without changing basic letter recognition features) to vary the appearance of individual letters to cue their sounds:
Increase/Decrease Size
Bold (if word already bold, then bold+increased size)
Shades of Gray (color)
CW-CCW Rotation
+/−Elevation
+/−Spacing
Dots (between segments)
Gray underline (blends)
Shape Distortion (morph just width or height or angular distortion)
Using two or more fonts in the same word

By using special, but already existent fonts, embodiments of the present invention can add outlined fonts, while from custom fonts embodiments of the present invention may add partially filled-in outlined fonts. The appearance of cues can also be varied to fit the needs and preferences of different types of beginning and struggling readers (for example, large fonts with kiddie serifs for children). A first embodiment of the present invention may stay within the defined limits of font rendering/appearance variation rendering common to all software and hardware platforms. With special fonts designed to maximally enable and emphasize visual encoding other embodiments may do more and rendering may readily evolve through trials and, later, more widespread use.

Many of the kinds of confusion visual encoding logic targets can be cued with relatively simple and straightforward variations in font rendering, as detailed herein.

(LN) Letter-Name [Bold]

A first class of visual encoding provides beginning readers a way to determine when a letter's sound is to be read as its letter name and when it is not.

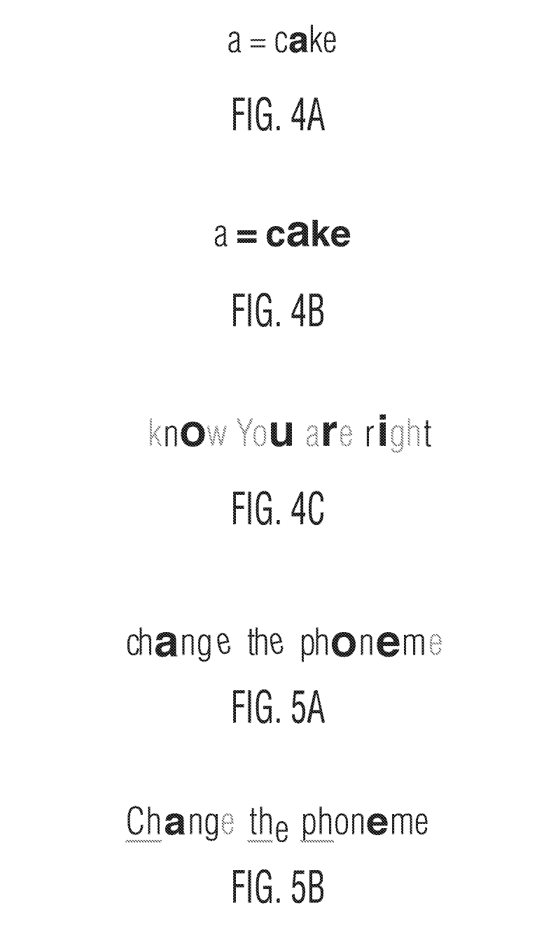

By using bold to indicate letter-name sounds, as shown in FIGS. 4A and 4B, there is a direct analogy of form to the letter name's difference in sound and the recognition of the visual cue is minimally abstract—more intuitively obvious—and therefore easier to remember. Larger bold may be used for letter-name sounds when the entire word is already rendered in bold. An example of such encoding is depicted in FIGS. 4A and 4B.

(SL) Silent Letters [Gray]

Silent/Unpronounced (possibly minimally pronounced) are visually encoded rendered in GRAY, as shown in FIG. 4C.

By graying silent letters, there is a direct analogy of form to the letter name's difference in sound and a minimally abstract and maximally analogous, intuitive, and easy way to recognize and remember the use of the cue.

(CL) Combined Letter Sounds (th. Ph. Ch. Sh. Etc. . . . ) [−Kerning]

Reducing the space between letters (kerning) may be used to cue readers to recognize such groups and to indicate that they are to make their own sound. This immediately removes the combined letters (blends, digraphs, trigraphs) from consideration for isolated decoding, as shown in FIG. 5A.

The letter spacing of the “ch” in “change”, the “th” in “the”, and the “ph” in “phoneme” are nearly in contact with one another (obviously differently spaced) to cue that they are letter combinations to be read as one unit. Placing letters in contact with one another to indicate that they are to be read as a group is a perfect morphic analogy.

(CL) Combined Letters Sounds and/or Blends [Gray Underlining]

In addition to or as an alternate to reducing the space between letters we can underline combined (th, ph, ch, sh, etc. . . . ) or blended (bl, tw, oo, st, etc. . . . ) letters, as shown in FIG. 5B.

(SG) Segmentation [+Kerning]

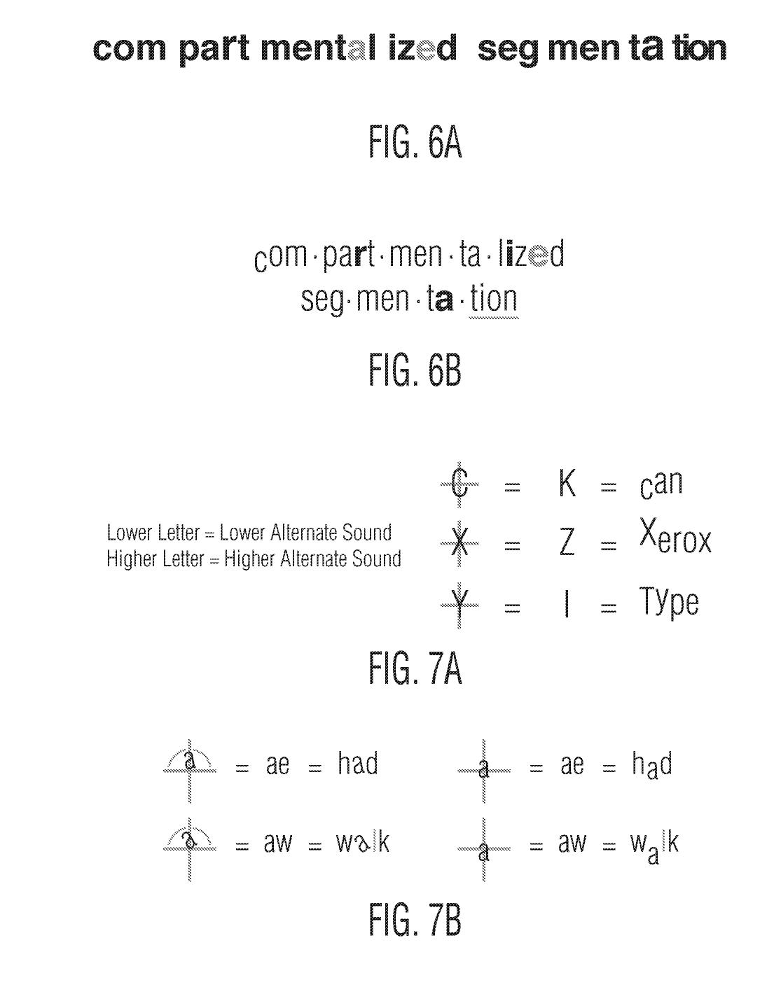

To avoid the decoding problems posed by “longer” words, visual encoding extends the space between letters (+kerning) to cue syllable boundaries, as shown in FIG. 6A.

(SG) Segmentation [Dots]

An alternate to increasing the space between segments we can use the traditional dictionary approach of inserting dots, as shown in FIG. 6B.

With straightforward cues for Letter Name (LN), Silent (SL), Combined (CL), and Segments (SG) addressing the simpler confusions, we can address the more complex variables associated with the remaining alternate letter sounds

Logic and Rendering: Alternate Letter Sounds (Complex)

Once we can rely on the letter-name (LN) cues to indicate when a letter is making its lettername sound, those letters that have only one non-letter-name sound can be left as is. For the remaining letters that have more sounds than the letter-name, silent, and combined visual encoding cover, we can make further distinctions about their sound differences that can be used to cue recognizing them.
Pitch—Alternate letter sounds have higher or lower pitches than then their letter names (for example: the first “y” in mystery and dynasty is making a short “i” sound and the second “y” is making the “e” sound. The short “i” sound, is a lower pitch than the “e” sound).
Slice—Alternate letters sounds often have some part or “slice” of the letter's letter-name sounds. (for example: the “s” in one embodiment's visual encoding is making the “z” sound which is the later part of the whole “S” sound).
Duration—Alternate letter sounds can be longer or shorter in duration than their letter-name sounds. (for example the short “a” in cat vs the long drawn out “a” in walk.
Spectrum—Sometimes all the sounds of a letter are internally related variations as in the case with the letter “a”, which in addition to the LN “a” sound can also sound like aw (talk), or ae (dad). In this sense, “a”, “ae” and “aw” are variations along a spectrum of sounds the “a” makes.
Discreteness—Some letters have letter sounds that do not sound at all similar, as in the case with the letter “c”, which can also sound like the totally different sound “k”.

Rendering Options for Alternate Letter Sounds (AL)

(AL-DL) Alternate Letter Sounds—Discrete: Many letters are used to represent sounds that have no resemblance to their letter name sound (“c” as “k”, “s” as “c”, “x” as “z”, etc.). One approach to cueing is to draw upon their difference in pitch. Each different letter sound can be distinguished as being either lower or higher in tone or pitch than the letter's LN sound. Using this basis for discrimination, we change the elevation of the letter as a cue for prompting the reader to know that this letter has discrete letter sounds as opposed to a spectrum of letter sounds and, subsequently, which of the letters alternate sounds it is to make. Such an embodiment is illustrated in FIG. 7A.

The “c” in “can” is a “k” sound that is lower in pitch than its LN and can be represented by lowering it. The “x” in “xerox” is a “z” sound and can be represented by raising it. Vertical centering or elevation represents a visually-conceptually analogous rendering.

(AL-SP) Alternate Letter Sounds—Spectrum: As with the “discrete” alternate letter sounds, each spectrum (“a”, “ae”, “aw”, etc.) letter's alternate sounds can be represented on a scale within which each alternate sound is either “lower” or “higher” in tone/pitch than its letter name sound. For example, the “i” in “animal” sounds like “eh” which is a “lower” tone then the “i” in “his” which sounds like “ih”. One such example is depicted in FIG. 7B.

The “a” in “had” is lower in tone than it's LN and can be represented by rotating it backwards or lowering it. The “a” in “walk” is even lower in tone than the “a” in “had” and can is represented by a greater exaggeration of rotation or lowering.

Visually Encoding Alternate Letter Sound Styles

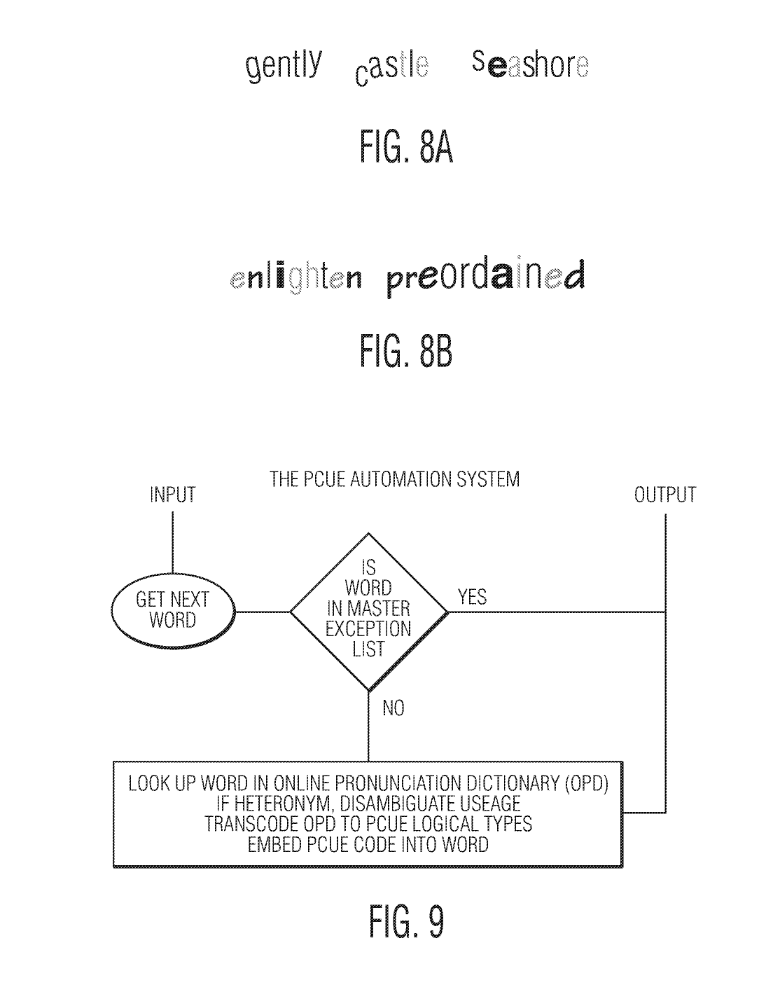

Other embodiments may use rotation for spectrum cues and elevation for discrete cues, such as, by way of example, that shown in FIG. 8A.

Affixes at the beginning (prefixes), the middle (infixes) or the end (suffixes) of words can be visually encoded by using a different font to render them, as shown in FIG. 8B.

A final visual variation styles for the cues may result from a collaborative effort which includes reading specialists, graphic artists, font designers and, of course, extensive learning and testing with developing readers. However, of the cues described here, a preferred embodiment includes the following starting set: Letter Name (LN), Combined Letter (CL), Silent (SL) and Segmentation (SG) cues. This set offers significant ambiguity reduction, are easy to recognize and appear as visual analogs of the pronunciation directions they cue.

Of the more complicated remaining cues, certain embodiments may favor elevation for discrete letter cues (DL) and an either duration or rotation for spectrum letter cues (SP).

The visual encoding component of a preferred embodiment of the present invention system has three main components:
The visual encoding automation system
The authoring/assignment tool
The reader app/browser plug in

The foregoing may be visualized systematically as shown in FIG. 9.

Such an automation system may be an intelligent backbone of embodiments that transcode human readable text into text-to-speech (machine) pronunciation code and subsequently to the visual encoding code (which may be embedded in the word as a mark-up language). The visual encoding automation system may consist of:
Master Exception List—list of manually cued words that bypass automation Online Pronunciation Dictionary (OPD)—open source or proprietary text-to-speech code library
Rule Application Engine—transcodes (OPD) code into visually encoded code

The visual encoding program may automatically assign and embed visual encoding code (mark-up language) to words not found in the Master Exception List. After disambiguating heteronyms, it may look-up (OPD) the phonetic/pronunciation code of a word and transcodes the results into visual encoding code according to the Rule Application Engine. The program may then return words with (invisible to humans) visual encoding code embedded in the word.

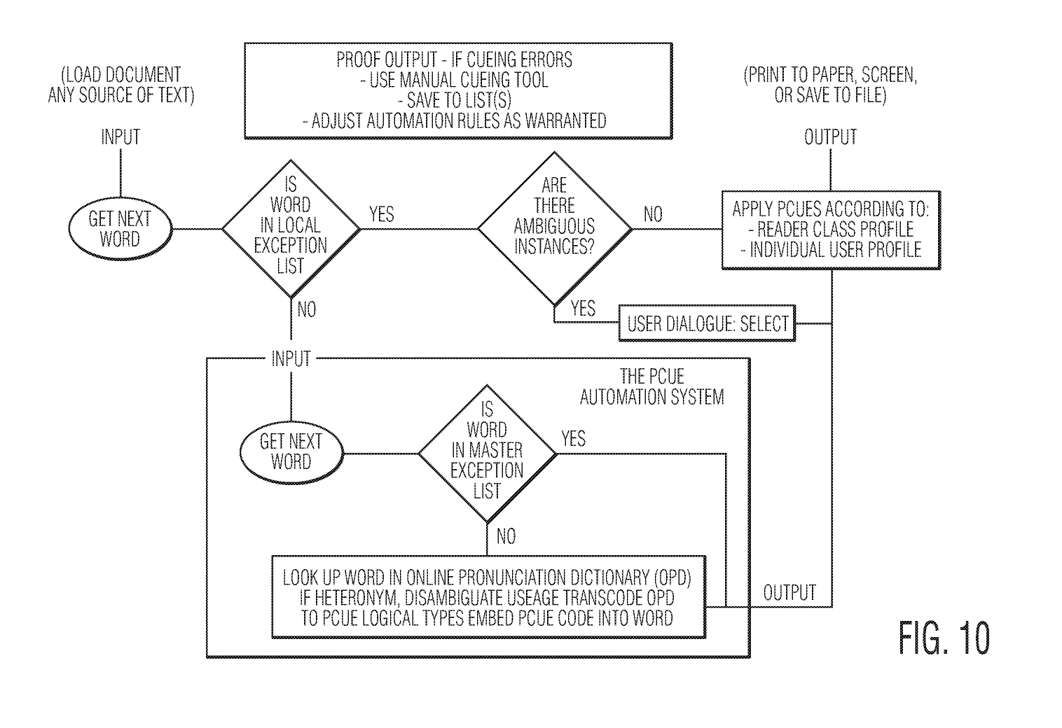

The foregoing may be represented logically as depicted in FIG. 10.

The Authoring/Assignment Tool allows content publishers/educators to personalize the application of visual encoding to their content and to their learners. The application may be hosted on a website and could be a plug-in for common word processors and publishing tools. The tool can open the content from common files or have it pasted into its workspace. It may output visually encoded texts that can be saved, copied, and pasted into popular word processing and publishing software, or directly printed.

The major components of the tool may include:
Local Exception List—list of manually cued words that bypass both the master exception list and the visual encoding automation system
CUE Bias Setting—provides the ability to exaggerate the rendering of visual encoding Font Styles (make letter name (LN) cues larger, change grayscale of (SL) cues, increase (SG cues) or decrease (CL cues) space between letters, increase or decrease the elevation of (AL-DL) cues, increase or decrease the morph of (ALDUR) cues.
Reader Class Profile—a modifiable list of preferences that includes assignations of visual encoding font styles to visually encoded code and selective disabling of individual visual encodings
Individual Reader Profile—a modifiable list of preferences for individual students that includes selective enabling and disabling of individual visual encoding (including various blends and affixes)
The Manual Visual Encoding Assignment Editor—while the system evolves to include visual encoding for every word in the English language there will be instances when the automation fails to cue a word correctly. The Manual visual encoding assignment editor is a human interface dialogue that allows authors and educators to manually assign visual encoding to the letters in a word. The resulting visually encoded word is then added to the Local Exception List and submitted to a “literacy team” which will either adjust the Rule Application Engine that controls the automation or add it to the Master Exception List (so that, one way or the other, the overall system learns).

The Reader App and Browser Plug-In are analogous to “receivers” or “players” designed to display pre visually encoded texts or to process any other texts into visually encoded text via the Visual Encoding Automation System.

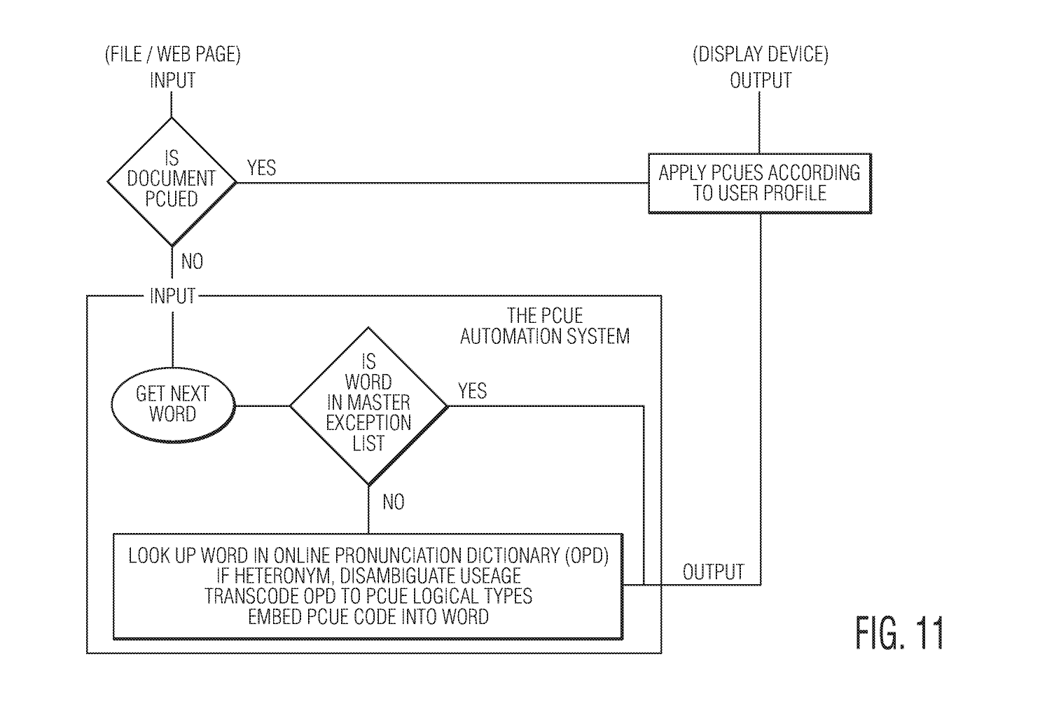

The foregoing may be represented logically as shown in FIG. 11.

The Reader App may be designed to run on PCs, tablets, and smartphones. The Browser Plug-In may be an extension that adds visual encoding reader functionality to common web browsers and allows for the dynamic visual encoding of most web-page content. Both the Reader App and Browser Plug-In may provide student users (and their teachers/parents) the ability to adjust the exaggeration of the cues as well as to enable or disable any particular cue.

Assessments

A preferred embodiment of the present invention may use student assessment data to create student-specific exercises and content and to adaptively focus and sequence accompanying instruction. In such embodiment, there are four kinds of assessments: exercise-assessments, content-assessments, exposure-assessments, and survey-assessments, as explained more fully herein.

Exercise-assessments measures student performance on various sub-processing (training) exercises and collects the following three types of data, such as, for example, the following:
1) Speed—letters, sounds, or words per minute
2) Errors—incorrectly processed letters, sounds, or words
3) NEMO—Negative emotional responses to errors
   −1=Frustrated (fidgety—angry)
   −2=Embarrassed (frowning, slumping, avoiding)
   −3=Shut Down (quits or wants to quit)

Content-assessments measure student performance in reading documents and collect the same data as exercise-assessments (above) with the following additional types, such as, for example, the following:
1) Comprehension—errors in understanding what is read
2) PEMO—Positive emotional responses to reading
   +3=Ecstatic, Radiating Enjoyment (smiling, wide open bright eyes)
   +2=Keenly Interested (focused, “leaning into”)
   +1=Engaged (flowing, buoyant)

Exposure-assessments collect student sight words, oral words, sight phrases, oral phrases, and picture vocabulary.

Survey-Assessments collect information about the student from the student.

Assessment Modules

A to Z Write and Say (A-Z): In this exercise-assessment, the student writes (or types) each letter of the alphabet and (while doing so) says out loud its letter name and most common sound(s). Each letter sound pronounced is assessed for errors and each error (letter-sound pattern) is recorded along with the student's negative emotional response (if any) to the error.
Letters Errors: errors (LE) in visual recognition of letters.
Sound Errors: errors (SE) in recognizing or producing each letter's name and most common sounds.
A-Z Emo: negative emotional (NEMO) responses to errors in recognizing letters or associatively producing their letter names and common sounds.
A-Z Speed: Letters per minute (LPM) rate of processing letters and their letter names and most common sounds.

Personal Survey Assessments (PSA): Template-based interview-survey-dialogues that capture, (among other information valuable to humans) words used or chosen by students when responding to questions, a weighted list of student interests, and the student's self-explanation for reading difficulties.
Personal Information: family, friends, pets, home, school.
Interests: favorite topics, themes, memes, names.
Self-Descriptions: personal story and explanatory concepts re reading issues.

Picture Vocabulary Assessment (PVA): Exposure-Assessments to pictures associated with words. Each picture is presented to the student who (in 2 seconds or less) either: A) says a word that can be associated with one of the picture's meanings (POW) B) fails to recognize the picture (PUW).

Vocabulary Assessments (VA): Exposure-assessments to words and phrases captured during personal surveys (PS) or from (pre-determined) grade-category (GCW) word lists (approx. 20 categories and 13 grade levels of difficulty). Each word or phrase is presented to the student who (in 2 seconds or less) either: A) correctly pronounces the word or phrase demonstrating sight recognition B) fails to recognize the word or phrase on sight but does demonstrate recognition when heard c) fails to recognize the word or phrase on sight or when heard. Vocabulary Assessments result in Assessed Student Words (ASWs) which are coded in one of the following ways:
Sight Words (SW): Grade-category words (GCWs) recognized on sight.
Core Sight Words (CSW): Sight word recognition of words used or chosen during personal surveys (PS).
Oral Words (OW): Grade-category words (GCWs) not recognized on sight but known orally.
Core Oral Words (COW): Words not recognized on sight but used or chosen during personal surveys (PS).
Unrecognized Words (UW): Grade-category words (GCWs) not recognized on sight or when heard.

Sight Word Sentences (SWS): Exercise-assessments that measure student performance in reading sentences constructed entirely (100%) from their own Sight Words.
SWS-Speed: speed (WPM) in reading sight-word-sentences.
SWS-Errors: errors in reading sight-word sentences.
SWS-Emo: negative emotional (NEMO) responses to errors in reading sight-word sentences.

Word Mark-Up (WM): Exercise-assessments that measure student performance in identifying and marking visually encoded letter patterns in Sight Words (SW and CSW).
WM-Speed: speed of applying visual encoding to letters in sight words (WPM).
WM-Errors: errors in applying visual encoding to letters in sight words.
WM-Emo: negative emotional (NEMO) responses to errors in recognizing or applying visual encoding to letters in sight words.

Word Scope (WS): Exercise-assessments that measure student performance in systematically applying visual encoding to work out pronunciation based recognition of non-sight oral words (OW and COW).
WS-Speed: speed of applying visual encoding to work out pronunciation/recognition of oral words (WPM).
WS-Errors: errors in applying visual encoding to work out pronunciation/recognition of oral words (WPM).
WS-Emo: negative emotional (NEMO) responses to errors in applying visual encoding to work out pronunciation/recognition of oral words.

Word Density (WD): Exercise-Assessments that measure student performance in reading contiguous passages at various levels of presentational density (isolated double spaced large font sentences to single spaced small font full pages).
WD-Speed: rate of reading at increasing levels of content density (WPM).
WD-Errors: errors in reading increasing levels of content density (WPM).
WS-EMO: negative emotional (NEMO) responses to errors at increasing levels of content density.

Visually Encoded Sentences (PCS) Exercise-Assessments that measure student performance in reading sentences constructed of progressively greater numbers of visually encoded oral words.
PCS-Speed: rate of reading sentences with x-number of unfamiliar visually encoded words (WPM).
PCS-Errors: errors in reading unfamiliar visually encoded words.
PCS-EMO: negative emotional (NEMO) responses to errors in reading unfamiliar visually encoded words.

Reading 1 (R1): Content-Assessments that measure student performance in reading extended length content that has been adapted to “fit” the student's vocabulary and interests and in which all non-sight words are visually encoded.
R1-Speed: rate (WPM) reading pages of student-fit, visually encoded content.
R1-Errors: errors reading pages of student-fit, visually encoded content.
R1-Emo: negative emotional (NEMO) responses to errors in reading pages of student-fit, visually encoded content.
R1-Comp: comprehension of reading pages of student-fit visually encoded content.
R1-Pemo: positive emotional responses to reading pages of student-fit, visually encoded content.

Reading 2 (R2) Content-Assessments that measure student performance in reading extended length content that has been adapted to “fit” the student's vocabulary and interests and in which none of the words are visually encoded.
R2-Speed: rate (WPM) reading pages of student-fit, non-visually encoded content.
R2-Errors: errors reading pages of student-fit, non-visually encoded content.
R2-Emo: negative emotional responses to errors in reading pages of student-fit, non-visually encoded content.
R2-Comp: comprehension of reading pages of student-fit, non-visually encoded content.
R2-Pemo: positive emotional responses to reading pages of student-fit, non-visually encoded content.

Reading 3 (R3) Content-Assessments that measure student performance in reading extended length content that has not been adapted to “fit” the student's vocabulary and interests and in which none of the words are visually encoded.
R3-Speed: rate (WPM) reading pages of non-student-fit, non-visually encoded content.
R3-Errors: errors reading pages of non-student-fit, non-visually encoded content.
R3-Emo: negative emotional responses to errors in reading pages of non-studentfit, non-visually encoded content.
R3-Comp: comprehension of reading pages of non-student-fit, non-visually encoded content.
R3-Pemo: positive emotional responses to reading pages of non-student-fit, non-visually encoded content.

Exercises

A preferred embodiment of the present invention uses both student-general and studentspecific exercises to build up the sub-processing proficiencies necessary for reading. Each exercise in a preferred embodiment of the present invention may be used for both improving learning-performance and assessing learning-performance (“Assessments”).

Student-general exercises may use the alphabet, letter sounds, and rapid naming props to develop, strengthen, and speed up proficiency with the fundamental elements (letters, sounds, letter-name and most common letter sounds) of reading.

Student-specific exercises may use the student's assessed inventory of letters, sounds, pictures, words and meanings to develop, strengthen, and speed up phonemic differentiation, word recognition, fluency, and comprehension.

Exercise modules may include the following.

A to Z Write and Say (A-Z): The student writes (or types) each letter of the alphabet and (while doing so) says out loud its letter name and most common sound(s). This training exercises the brain's differentiation of the elements and the most basic associations between those elements. A timer may be used to provide real-time performance feedback to the student.
A to Z Sub Exercise (LEs): practice writing/manipulating letters revealed as letter recognition errors (LEs) by A-Z Assessments.
A to Z Sub Exercise (SEs): practice using (rhyming and other) words that exemplify sound differentiation/articulation errors (SE) revealed by A-Z assessments.

Picture Word Sentences (PWS): The student “reads” out loud the words associated with a sequence of pictures known to be in the student's picture oral words (POWs) that, as a sequence (rebus like), read like sentences. By using sentences made of 100% student POWs, the student's serial linear processing, rate of processing, accuracy, and confidence in processing can be improved and sped up independent of the challenge of written word recognition.

Sight Word Sentences: The student “reads” out loud sentences composed of words known to be in the student's sight word (SW and CSW) vocabulary. By using sentences made of 100% student sight words, the student's serial linear processing, rate of processing, accuracy, and confidence in processing can be improved and sped up independent of the challenge of unfamiliar word recognition.

Picture-Text Word Mark-Up: The student is presented with filtered lists of pictures and their accompanying words (CPOWS or POWs). Each filtered list includes only pictures/words that exemplify a particular letter sound (visually encoded) relationship. For example, in the “letter names” list, words are presented only if they have a least one constituent letter that “makes” its letter name sound (the word “Ape” for example contains the letter name “a”). The student then, word by word, indicates every letter that “makes” its letter name sound. The same process of indicating visually encoded letter sound patterns may be used for the full range of visually encoded patterns (letter names, silent letters, schwas, segment breaks, combined letters, blended letters, and alternate letter sounds). By using student CPOW and POW pictures and words, there is no need to decode the word. Students apply their knowledge of the sound of letters to learning the letter sound patterns in words.

Word Mark-Up: The student is presented with filtered lists of sight words (SW and CSW). Each filtered list includes only sight words that exemplify a particular letter sound (visual encoding) relationship. For example, in the “letter names” list, words are presented only if they have a least one constituent letter that “makes” its letter name sound (the word “Old” for example contains the letter name “O”). The student then, word by word, indicates every letter that “makes” its letter name sound. The same process of indicating visually encoded letter sound patterns may be used for the full range of visually encoded patterns (letter names, silent letters, schwas, segment breaks, combined letters, blended letters, and alternate letter sounds). By using student sight words, there is no uncertainty between the appearance of a word and its sound. This allows students to apply their knowledge of the sound of a word to learning the letter sound patterns in that word.

Picture-Text Word Scope: The student is presented with one-at-a-time picture and word (text) combinations from a filtered list of picture oral words (CPOW and POW). Each filtered list only includes picture and word combinations that exemplify a particular letter sound (visual encoding) relationship. For example, if the “schwa” list is selected, picture/words are presented only if they have a least one constituent letter that “makes” the schwa sound (the second letter “a” in the word “Santa” for example makes the schwa sound). The student then, word by word and letter by letter indicates every letter that makes the schwa sound. The same process of indicating visually encoded letter sound patterns may be used for the full range of visually encoded patterns (letter names, silent letters, schwas, segment breaks, combined letters, blended letters, and alternate letter sounds).

Word Scope: The student is presented with one word or phrase at a time from a filtered list of oral words (OW and COW). Each filtered list only includes oral words that exemplify a particular letter sound (visual encoding) relationship. For example, if the “schwa” list is selected, words are presented only if they have a least one constituent letter that “makes” the schwa sound (the letter “e” in the word “the” for example makes the schwa sound). The student then, word by word, indicates every letter that makes the schwa sound. The same process of indicating visually encoded letter sound patterns may be used for the full range of visually encoded patterns (letter names, silent letters, schwas, segment breaks, combined letters, blended letters, and alternate letter sounds). As students progress in their facility with the distinctions, a greater number of visually encoded patterns are group-selected and the student is presented with ever more complex words with which to use any number or all of the visually encoded patterns to work out word recognition. By using oral words (OW and COW) students know the word they are working on is a word they would know if they heard it. This allows students to learn to apply a systematic method of word recognition without the uncertainty involved in learning to read words not in their oral vocabulary.

The foregoing embodiments may be further understood with reference to the accompanying materials, reproduced below and incorporated herein by reference.

The foregoing Summary of the Invention is not intended to limit the scope of the disclosure contained herein nor limit the scope of the appended claims. To the contrary, as will be appreciated by those persons skilled in the art, variations of the foregoing described embodiments may be implemented without departing from the claimed invention.

Phonetic Transcription

Common daily-use machines (including PCs, Tablets, Smartphones and GPS devices) routinely do what struggling readers experience great difficulty doing: they ‘read’ and correctly ‘pronounce’ words. This text-to-speech capability is made possible by phonetic transcription systems and online pronunciation dictionaries that transliterate words (from human lexicons) into the machine-language instructions used by digital devices to produce the (phonemes) that result in the words being ‘pronounced’.

Embodiments of the present invention provide a new layer to phonetic transcription systems that maps the letter-sound values of their notational elements to corresponding visually encoded letter-sound-values. This yields two significant benefits: (1) visually encoded letter-sound-values can be used as keys for searching and processing the lexicon of the transcription system, and (2) the transcription codes of the system can be directly mapped to visual encoding style codes for font printing instructions (bold, gray . . . ). Thus, rather than the transcription system's output being ‘sound’ it can become variations in the appearance of letters (visual encoding) that cue human readers to articulate (silently or audibly) the right sounds.

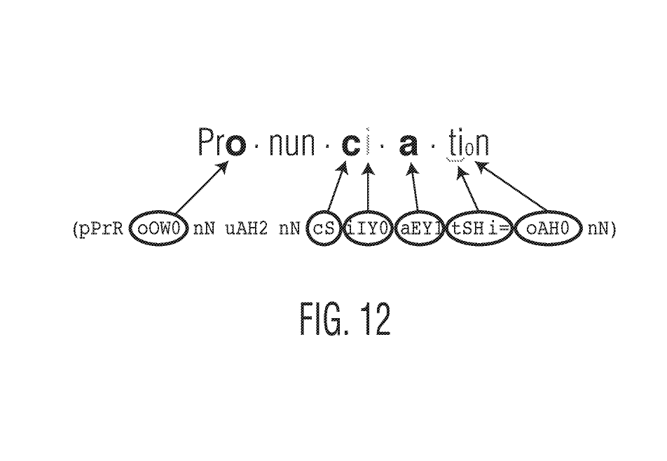

One of the most common phonetic transcription systems is the Arpabet. The Arpabet represents each phoneme of General American English with a distinct sequence of ASCII characters. Embodiments of the present invention may implement visual coding by aligning a word's Arpabet sequence of sounds with the word's sequence of letters and uses the Arapabet's sound coding to specify each letter's letter-appearance (visual encoding) variations, as shown in FIG. 12.

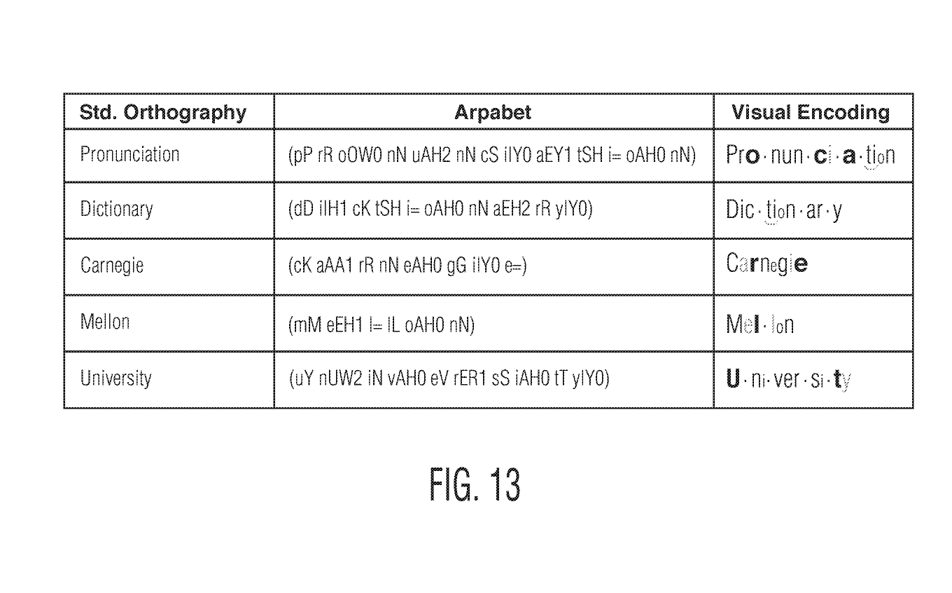

Orthographical mappings of embodiments of the present invention may be illustrated as shown in FIG. 13.

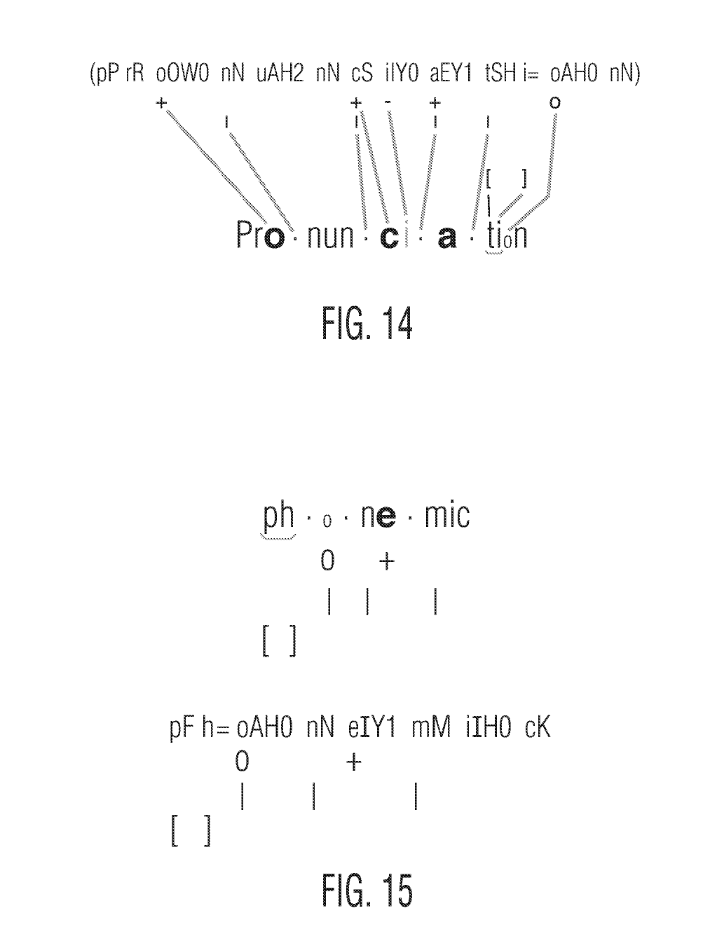

From this, embodiments of the present invention may map visual codings using, for example, the following html font display and printing instructions comprising three channels of coding: 1-Single letter, 2-Segmentation, 3-Grouping, as follows.
Channel 1—Single Letter channel is used to apply formatting to single letters:
   + Letter Name=BOLD
   − Silent=GRAY
   ̂ Alternate Letter Sound Higher=UP
   _ Alternate Letter Sound Lower=DOWN
   > Alternate Letter Sound Spectrum=STRETCH
   ∘ Schwa sound=SHRUNK
   4 ER sound=ROTATE CLOCKWISE and SUBSCRIPT
Channel 2—The Segmentation channel is used to insert spacing dots that indicate segmentation breaks in longer words:
         | Segmentation=DOTS indicating syllable breaks
Channel 3—The Group channel is used to indicate which letters are to be combined or blended:
   ( ) Blended Letters=DOTTED UNDERSCORE
   [ ] Combined Letters=SOLID UNDERSCORE
   { } Groupings that indicate R-Controlled Pattern=ROTATE CLOCKWISE and SUBSCRIPT for R
      Aspects of the foregoing may be visually depicted as shown in FIG. 14, for example:

Visual encoding style codes can be directly (sometimes called “manually”) applied to traditional orthography or can be automatically applied to a phonetic transcription system, for example the Arpabet, via rules of association. Direct and intermediary based encodings are illustrated in FIG. 15.

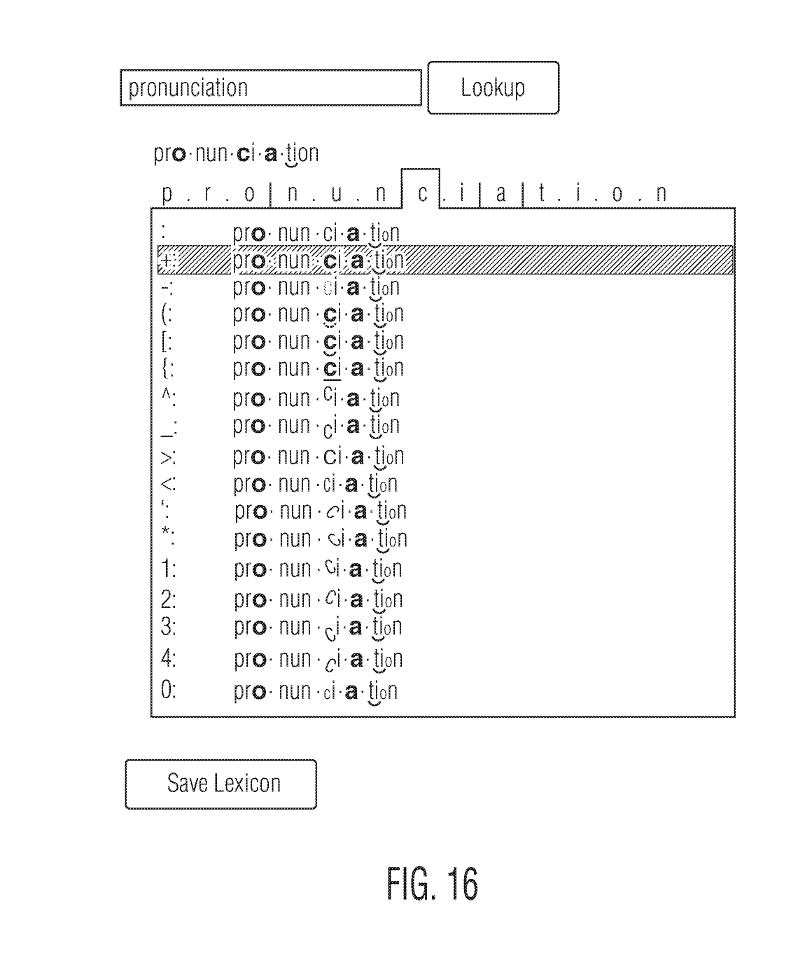

Direct coding may be facilitated by a GUI dialog box that enables human users to assign single letter, segmentation, and group style codes visually (without having to deal with the underlying coding). In the example shown in FIG. 16, the letter ‘c’ in the word pronunciation is selected all available visual encoding style options appear below it. Selecting a visual encoding style option assigns the selected option's visual encoding style code to that letter (in that word). In this case ‘+’ was assigned to the ‘c’ indicating that it is to be displayed/printed in bold.

Rule-based coding using intermediary orthographies may be applied for recurring letter-sound value patterns and phonemes by applying visual style codes to the transcription system's sound codes. For example the Arpabet uses e=′ to indicate that the e′ does not add additional sound to the letter(s) that precede it. In the frequent case of the silent e′ at the end of a word like ‘hope’ the Arpabet renders the word as (hHH oOW1 pP e=) where the e=′ is in effect silent. In embodiments of the present invention, this coding may be represented as: e=$ #final e's @SL, where the $ sign indicates ‘end of a word’, the # sign indicates a comment, and the @sign indicates a visual style code type (in this case silent letter) and the − sign indicates that the letter above it is to be rendered in gray. The rule (which GRAYs the e′ to indicate its silence in the word) is applied whenever an e=′ sound code occurs at the end of a word in the Arpabet's dictionary.

In embodiments of the present invention, such rules are used to associate unambiguous Arpabet letter-sound pattern codes to visual style codes (single letter, segmentation, group). When processing a document, words found in the transcription system's dictionary may be examined (via that system's phonetic coding) for visual style rule matches and visual styles may then be applied to the letters accordingly.

In preferred embodiments, visual style rules are used to represent all recurring unambiguous letter-sound patterns in a phonetic transcription system and manual visual styling is applied to words not in the dictionary of the transcription system or to words whose sound patterns are ambiguously represented in the transcription system.

Visual Encoding Analytics and Lexical Processing

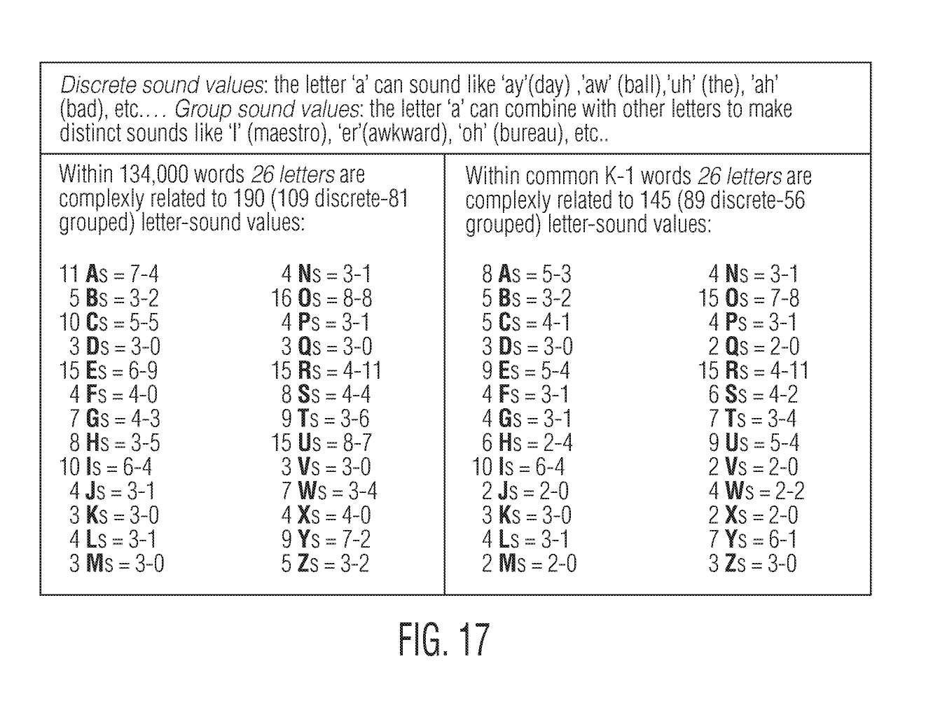

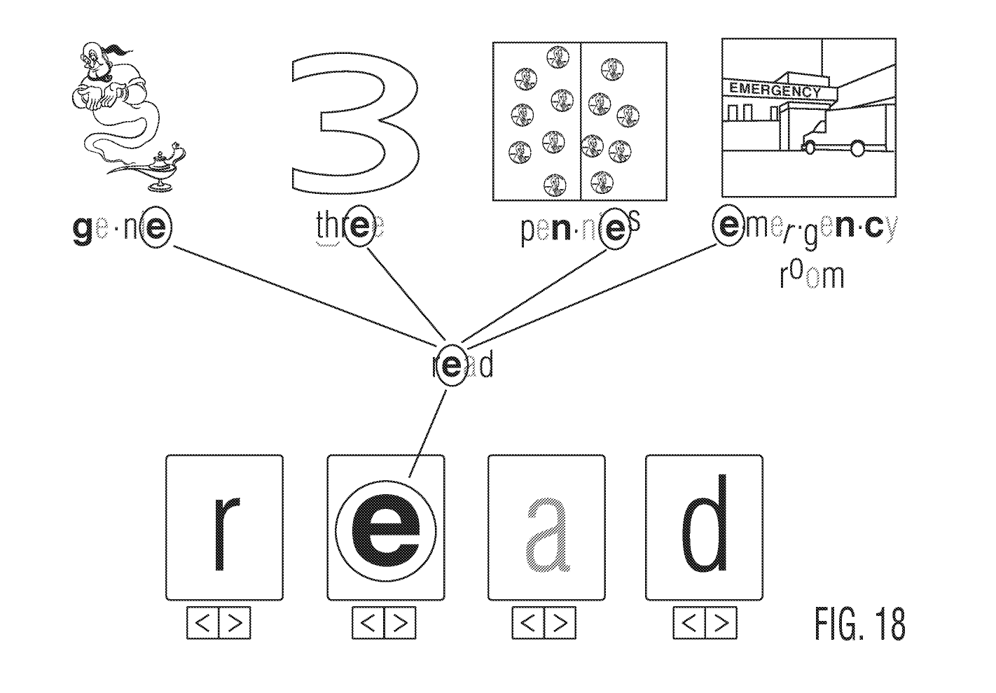

Visual encoding visual style types can be used to classify and process any lexicon/dictionary (including for example “classroom aggregate”, “personal” and “generic” vocabulary lists) into lists of words according to visually encoded type/style variations. For example, using the previously described styles to filter 134,000 words in an American English dictionary results in 190 discrete and group sound values. Using the same styles to filter only 455 of the most common K-1 words results in 145 discrete and group sound values. Using visual codings in combination with other attributes of words such as # of letters, # of segments, part of speech, grade level, semantic categories and others makes it possible to select words that more finely match instructional objectives (K-6 nouns (names) for animals that are less than 8 characters and the exemplify the ‘th’ combination: ‘mammoth’, ‘moth’). This is summarized in FIG. 17.

Using the aforementioned lexicon processing may enable assisted teaching tools to search dictionaries such as the previously mentioned personal, class-aggregate, grade-level and generic dictionaries to find and present to students words that exemplify the coded sound value of the letter with which the student is interacting, presenting to the student a known word (i.e., previously known and readable by the student). In such embodiments, selecting a letter's coded sound value (in the example below, the letter-name/bold ‘e’) may result in the presentation of words that exemplify that letter's currently visually coded sound value. The example words may be chosen by matching words in one or more of the aforementioned dictionaries that have the same letter in the same visually encoded form as the selected letter (bold ‘e’), as depicted in FIG. 18.

Dictionaries

Embodiments of the present invention may use and in some cases create a number of different kinds of dictionaries. Such embodiments can process any online dictionary of any size and may include a predefined (“curated”) dictionary of over 10,000 K-12 words. Such embodiments may further create and evolve dictionaries specific to each student-user and may aggregate all the dictionaries of a school, classroom, or group of student-users. These various dictionaries, processed through the search/filtering power of visual encoding, may be used to adapt the content flowing through the various components of the system to better fit each student or group of students that use it.

In a preferred embodiment, the present invention uses the Arpabet as a resource for accessing phonetic information about the pronunciation of the 134,000 words it contains. Extending the Arpabet allows embodiments of the present invention to evolve a dictionary of thousands of words whose patterns are too ambiguous for existing phonetic transcription systems and that have been manually visually encoded (i.e., manually visually encoded).

A preferred embodiment of the present is differentiated by 14 grade levels and an expandable number of thematic categories with over 10,000 high frequency K-12 words in its a predefined dictionary (referred to at times as the “Vocabulary Assessment Dictionary”). In this embodiment, each word is tagged with information that includes: grade; category; parts of speech roles; syllable count; and letter count. Furthermore, in this embodiment all K-6 grade words are also accompanied with recorded human voice pronunciations, and all K grade words with accompanying pictures.

The Vocabulary Assessment Dictionary may be used to assess the oral and sight word vocabularies of each student-user. The result is an Assessed Student Words dictionary that contains every oral and sight word the system has confirmed to be known by the student (and which grows through post vocabulary assessment use). Each student's assessed student words dictionary may contain: oral words; sight words; core oral words; core sight words; and unknown words. Oral words that are not yet sight words may be represented by pictures and used as example words to teach visually encodedvisually encoded letter-sound distinctions and may be the best words for students to use when learning to decode (i.e., to read).

The Group Aggregate Dictionary may be a dynamically constructed list of Assessed Student Words that are shared by a particular group, class, or school. Each shared word in a group aggregate dictionary may be tagged with the number of members of the group that share it. Group Aggregate Dictionaries may be used to populate the example words used by various components of embodiments of the present invention when used by educators, parents or literacy volunteers to support simultaneous group instruction and learning.

Vocabulary Assessment

Embodiments of the present invention may include an Oral Vocabulary Assessment in which students match spoken words to pictures to assess which word-pictures are in their personal oral vocabularies. The resulting correctly matched words may then be added to the students Assessed Student Words dictionary and tagged as “Oral”.

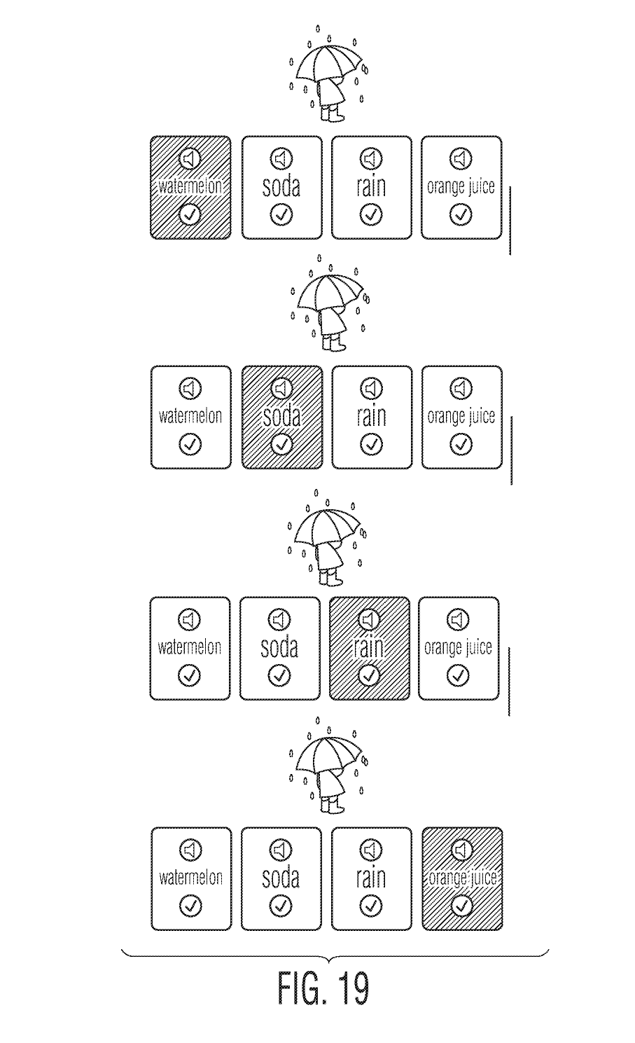

To assess oral vocabulary embodiments of the present invention may display one of the K-Grade Word-Pictures from the Vocabulary Assessment Dictionary, as depicted in FIG. 19, and then sequentially play the sound file recording of that word and 3 others words. The order of the words is preferably randomized. As each word's sound file is played the button box corresponding to it is preferably highlighted. Each button box preferably contains 2 buttons: “replay,” which replays the word sound should the student wish to hear it again, and “select,” which selects the heard word as the word the student thinks matches the picture. Preferably, after the last of the 4 word sounds are played a timer (that can be adjusted during set-up) begins counting down (the set-up established number of allotted seconds) to zero. If the student correctly matches the word the word is added to the student's oral words in his or her Assessed Student Words dictionary. If the student makes an incorrect selection, skips the word, or does not choose a selection in time the word is added to the student's Unknown words in his or her Assessed Student Words dictionary and the system automatically advances to the next word on the list. If a student thinks he or she incorrectly answered a previous word or wants more time he or she can use the left arrow to back up and restart the previous word or words.

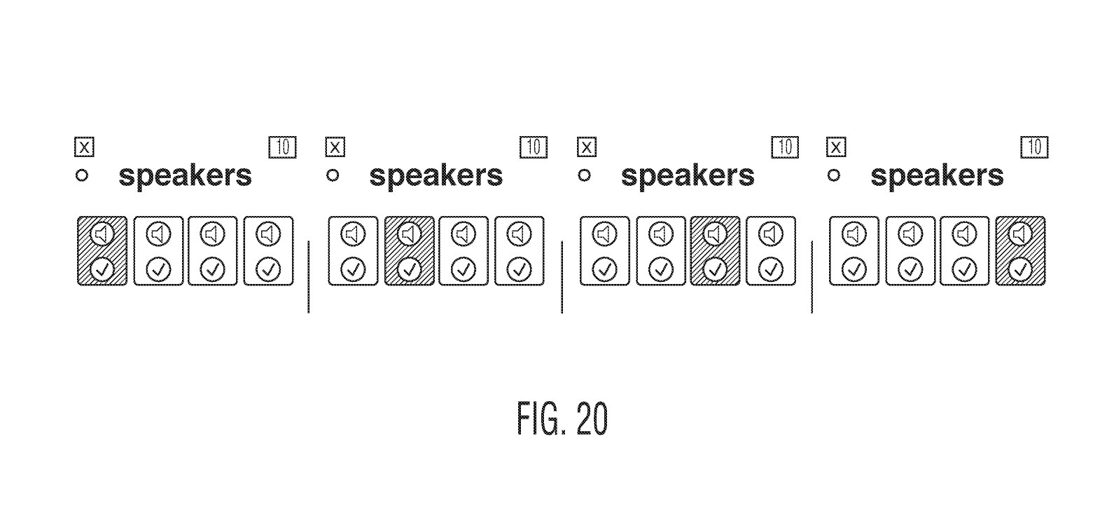

To assess Sight Word Vocabulary Assessment, embodiments of the present invention allow students to match spoken words to printed words, thereby assessing which words are in a student's personal sight word vocabulary. The resulting correctly matched words may then be added to the student's Assessed Student Words dictionary and tagged as “Sight”. To assess sight-word vocabulary, embodiments of the present invention may display the text of one of the words from the Vocabulary Assessment Dictionary, as depicted in FIG. 20, and then sequentially plays a sound file recording of that word and 3 others words. The order of the words is preferably randomized. As each word's sound file is preferably played the button box corresponding to it is highlighted. Each button box contains 2 buttons, “replay,” which replays the word sound should the student wish to hear it again, and “select,” which selects the heard word as the word the student thinks matches the written word. Preferably, after the last of the 4 word sounds are played, a predetermined timer begins counting down to zero. If the student correctly matches the word the word is added to the student's sight words in his or her Assessed Student Words dictionary and the system advances to the next word to be assessed. If the student makes an incorrect selection or does not choose a selection in time the system displays a new screen that presents the written word, plays the sound of the word, and audibly asks the student: “Are you certain you know the meaning of this word”. If the student answers “Yes” the word is added to the student's oral words in his or her Assessed Student Words dictionary. If the student answers “No” the word is added to the student's unknown words in his or her Assessed Student Words dictionary.

In other embodiments of the present invention, the system may present to students written words and ask the student to read them out loud. Words confirmed by speech recognition as correctly matching the assessed word may then be added to the student's sight words in his or her Assessed Student Words dictionary. Words recognized by speech recognition as incorrectly matching the assessed word may be followed by a screen requesting the student explain the meaning of the word. The student's explanations, post speech recognition, may then be scanned for key words associated with the word's meaning. If the key word(s) are present the word can be added to the student's oral words in his or her Assessed Student Words dictionary. If the student fails to articulate the key word(s) the word can be added to the student's unknown words in his or her Assessed Student Words dictionary.

Although the particular embodiments shown and described above will prove to be useful in many applications in the art to which the present invention pertains, further modifications of the present invention will occur to persons skilled in the art. All such modifications are deemed to be within the scope and spirit of the present invention as defined by the appended claims.

What is claimed is:

1. A method for visually encoding a target word comprising the steps of:
(a) creating a phonetic transcription of the target word using a predefined phonetic transcription method, the phonetic transcription representing phonemes contained in the target word;
(b) defining a set of visual codings;
(c) defining an orthographical mapping between said phonetic transcription and visual codings from the set of visual codings; and
(d) applying the orthographical mapping to the phonetic transcription thereby visually encoding the target word.

2. The method of claim 1 wherein the step of defining a set of visual codings includes the step of defining at least one of a set of core encodings, a set of variable encodings and a set of group-variable encodings.

3. The method of claim 2 wherein the step of defining a set of core encodings includes the step of defining a mapping of visual styles to letter-sound functions wherein distinct visual styles are mapped to one or more of long sound functions, common sound functions, silent sounds and schwa sound functions.

4. The method of claim 2 wherein the step of defining a set of variable encodings includes the step of defining a mapping of visual styles to letter-sound functions wherein distinct visual styles are mapped to one or more of higher pitched sound functions, lower pitched sound functions, and longer/drawn out sound functions.

5. The method of claim 2 wherein the step of defining a set of group variable encodings includes the step of defining a mapping of visual styles to letter-sound functions wherein distinct visual styles are mapped to one or more of combined letters sound functions, blended letters sound functions, and ER sound functions.

6. The method of claim 1 wherein the step of defining a set of visual codings includes the step of defining morphic analogs of the phonemes represented in the phonetic transcription.

7. The method of claim 6 wherein the step of defining a set of core encodings includes the step of defining a mapping of visual styles to letter-sound functions wherein distinct visual styles are mapped to one or more of long sound functions, common sound functions, silent sounds and schwa sound functions.

8. The method of claim 6 wherein the step of defining a set of variable encodings includes the step of defining a mapping of visual styles to letter-sound functions wherein distinct visual styles are mapped to one or more of higher pitched sound functions, lower pitched sound functions, and longer/drawn out sound functions.

9. The method of claim 6 wherein the step of defining a set of group variable encodings includes the step of defining a mapping of visual styles to letter-sound functions wherein distinct visual styles are mapped to one or more of combined letters sound functions, blended letters sound functions, and ER sound functions.

10. A method for visually encoding a target word comprising the steps of:
(a) creating a phonetic transcription of the target word using a predefined phonetic transcription method, the phonetic transcription representing phonemes contained in the target word;
(b) defining a set of visual codings by defining a set of core encodings, a set of variable encodings and a set of group-variable encodings;
(c) wherein the step of defining a set of variable encodings includes the step of defining a mapping of visual styles to letter-sound functions wherein distinct visual styles are mapped to higher pitched sound functions, lower pitched sound functions, and longer/drawn out sound functions, the step of defining a set of variable encodings includes the step of defining a mapping of visual styles to letter-sound functions wherein distinct visual styles are mapped to higher pitched sound functions, lower pitched sound functions, and longer/drawn out sound functions, and the step of defining a set of group variable encodings includes the step of defining a mapping of visual styles to letter-sound functions wherein distinct visual styles are mapped to combined letters sound functions, blended letters sound functions, and ER sound functions;
(d) defining an orthographical mapping between said phonetic transcription and visual codings from the set of visual codings; and
(e) applying the orthographical mapping to the phonetic transcription thereby visually encoding the target word.

11. The method of claim 10 wherein the step of defining a set of visual codings includes the step of defining morphic analogs of the phonemes represented in the phonetic transcription.

12. The method of claim 11 wherein the step of defining morphic analogs includes the step of defining morphic analogs based on one or more of increase/decrease letter size, letter bolding, letter shading in gray, change of letter color, cw and ccw letter rotation, increased and decreased letter elevation, increased and decreased letter spacing, dots, gray underline, letter shape distortion, multiple fonts.

13. The method of claim 12 wherein the step of defining morphic analogs includes the step of defining raised font to code higher pitched phonemes.

14. The method of claim 12 wherein the step of defining morphic analogs includes the step of defining lowered font to code lower pitched phonemes.

15. The method of claim 12 wherein the step of defining morphic analogs includes the step of defining stretched font to code longer/drawn out phonemes.

16. The method of claim 12 wherein the step of defining morphic analogs includes the step of defining solid underline to code combined letters phonemes.

17. The method of claim 12 wherein the step of defining morphic analogs includes the step of defining dotted underline to code blended letters phonemes.

18. The method of claim 12 wherein the step of defining morphic analogs includes the step of defining lowered-rotated ‘r’ to code ‘er’ phonemes.
